(19) United States
(12) Patent Application Publication
(10) Pub. No.: US 2026/0195094 A1
(43) Pub. Date: Jul. 9, 2026

(54) THREE-DIMENSIONAL ACCELERATOR FOR GENERATIVE ARTIFICIAL INTELLIGENCE OPERATIONS

(71) Applicant: Taiwan Semiconductor Manufacturing Company, Ltd., Hsinchu (TW)

(72) Inventors: Murat Kerem Akarvardar, Hsinchu (TW); Xiaoyu Sun, Hsinchu (TW); Brian Crafton, Hsinchu (TW); Xiaochen Peng, Hsinchu (TW); Hidehiro Fujiwara, Hsinchu (TW); Yu-Der Chih, Hsinchu (TW); Jonathan Tsung-Yung Chang, Hsinchu (TW)

(73) Assignee: Taiwan Semiconductor Manufacturing Company, Ltd., Hsinchu (TW)

(21) Appl. No.: 19/014,862

(22) Filed: Jan. 9, 2025

(51) Int. Cl. G06F 7/544; G06F 12/08

(52) U.S. Cl. CPC G06F 7/5443; G06F 12/08

(57) ABSTRACT

Systems, devices, and methods of operating said systems and devices are disclosed. In one aspect, a system includes a plurality of memory layers each comprising a set of memory banks. The system can include a multiply-accumulate (MAC) layer comprising a MAC array having a plurality of MAC devices. Each MAC device of the plurality of MAC devices can be coupled to a respective memory bank of the set of memory banks by at least one via structure. The set of memory banks and the plurality of MAC devices can each be arranged in a predetermined number of rows and columns.

### BACKGROUND

An integrated circuit (IC) can contain a variety of hardware circuit devices or types of logic, including FPGAs, application-specific integrated circuits (ASICs), logic gates, registers, or transistors, in addition to various interconnections between the circuit devices. The IC can be manufactured using or composed of semiconductor materials, for instance, as part of electronic devices, such as computers, portable devices, smartphones, internet of thing (IoT) devices, etc. Developments and increasing complexity of the ICs have prompted increased demands for higher computational efficiency and speed. More specifically, the ICs can be configurable and/or programmable to perform computations in sequences or variations desired by the manufacturer, developer, technician, or programmer, among others.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a perspective block diagram of an example three-dimensional (3D) accelerator circuit implemented to process generative accelerate artificial intelligence (AI) operations, in accordance with some embodiments of the present disclosure.

FIG. 2 illustrates a perspective block diagram of an example multiply-accumulate (MAC) array layer that may be included in the 3Daccelerator circuit of FIG. 1, in accordance with some embodiments of the present disclosure.

FIG. 3 illustrates a cross-sectional block diagram illustrating interconnections between memory layers and the MAC layer of the 3D accelerator circuits described herein, in accordance with some embodiments of the present disclosure.

FIG. 4 illustrates a block diagram showing an example mapping of a set of weight values to memory elements in a memory layer of the 3D accelerator circuits described herein, in accordance with some embodiments of the present disclosure.

FIG. 5 illustrates a block diagram showing how other data values stored according to the mapping shown in FIG. 4 can be processed using the 3D accelerator circuits described herein, in accordance with some embodiments of the present disclosure.

FIG. 6 illustrates a block diagram showing how further data values stored according to the mapping shown in FIGS. 4 and 5 can be processed using the 3D accelerator circuits described herein, in accordance with some embodiments of the present disclosure.

FIG. 7 illustrates a block diagram showing how MAC devices of a MAC array of the 3D accelerator circuits described herein can process data values provided according to the mapping shown in FIGS. 4, 5, and 6, in accordance with some embodiments of the present disclosure.

FIG. 8 illustrates a block diagram showing another example mapping of a set of weight values to memory elements in a memory layer of the 3D accelerator circuits described herein, in accordance with some embodiments of the present disclosure.

FIG. 9 illustrates a block diagram showing how other data values stored according to the mapping shown in FIG. 8 can be processed using the 3D accelerator circuits described herein, in accordance with some embodiments of the present disclosure.

FIG. 10 illustrates a block diagram showing how a memory layer is aligned over MAC devices of a MAC array in the 3D accelerator circuits described herein, in accordance with some embodiments of the present disclosure.

FIG. 11 illustrates a flowchart of an example method to operate the disclosed circuits described herein, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Generative artificial intelligence (AI) operations, such as MAC operations, are often memory bandwidth constrained due to the amount of information that is to be propagated through circuitry responsible for performing said operations. Such memory bandwidth constraints result in delays in which computational circuitry is idle while data that is to be processed (e.g., weight data from artificial intelligence models, etc.) is accessed, retrieved, and loaded into appropriate registers/memory elements. These memory access delays significantly degrade the performance of conventional artificial intelligence accelerator circuits.

More particularly, artificial intelligence operations implemented by artificial intelligence circuits can include a prefill phase, where an input prompt with many tokens propagates through the network to generate the first output token, involving Matrix-Matrix Multiplications (MMMs); and a generation phase, where the next tokens are iteratively generated one-by-one, with each iteration generating the latest generated token as the new input to the transformer model, involving Matrix-Vector Multiplications (MVMs). Weight updates for artificial intelligence circuits are performed during the generation phase, where weights can in MAC circuits can be updated between performing MVM operations. As conventional artificial intelligence circuits are constrained to architectures that implement pipeline parallelism when performing weight updates, such circuits are significantly memory bandwidth limited, degrading device performance. Extending 2D existing circuits to perform weight updates in fewer cycles results in impractically large circuit routing complexity or area usage.

To address these and other issues, the techniques described herein provide three-dimensional (3D) accelerator circuits that include multiple layers of memory elements and at least one layer of processing elements that use location-aware weight mapping to significantly improve memory access performance. The 3D accelerators described herein implement multiple layers of memory devices that are coupled to at least one processing layer of compute components (e.g., MAC units, etc.) using 3D circuit interconnect structures, such as through-silicon vias (TSVs). The memory layers of the 3D accelerator and the MAC array can be connected such that weight values of a generative AI model can be written into MAC array in parallel and within a single cycle to improve device performance.

The 3D accelerator circuits described herein can implement a location-aware weight mapping, such that weight values of a generative AI model (e.g., a transformer-based model such as a generative pre-trained transformer (GPT) model, etc.) can be stored in memory banks/devices that are located above the compute circuits that are to process those weight values. Multiple memory banks/devices can be defined above the same compute circuit in additional memory layers of the 3D accelerator circuit. Storing particular weight values in memory banks/devices above the compute circuits that are to access those weight values eliminates the routing and circuitry to laterally move/shift the weight values among components of the same layer, significantly reducing memory access energy.

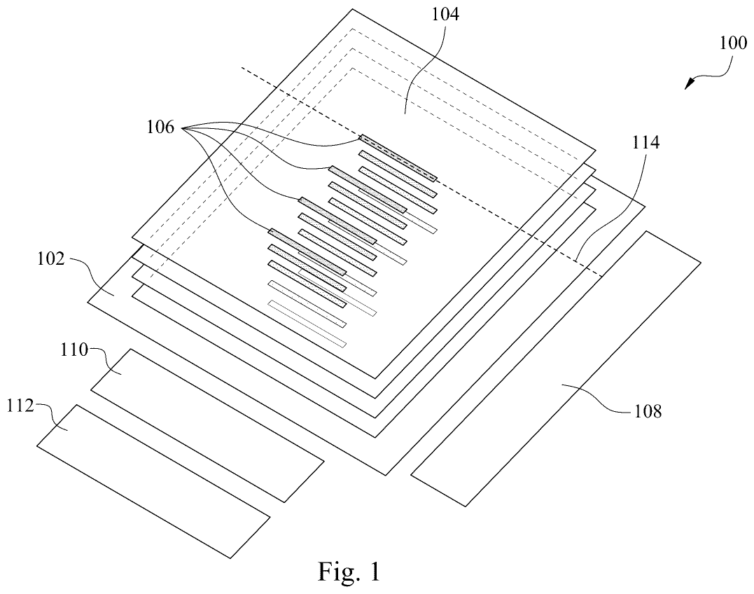

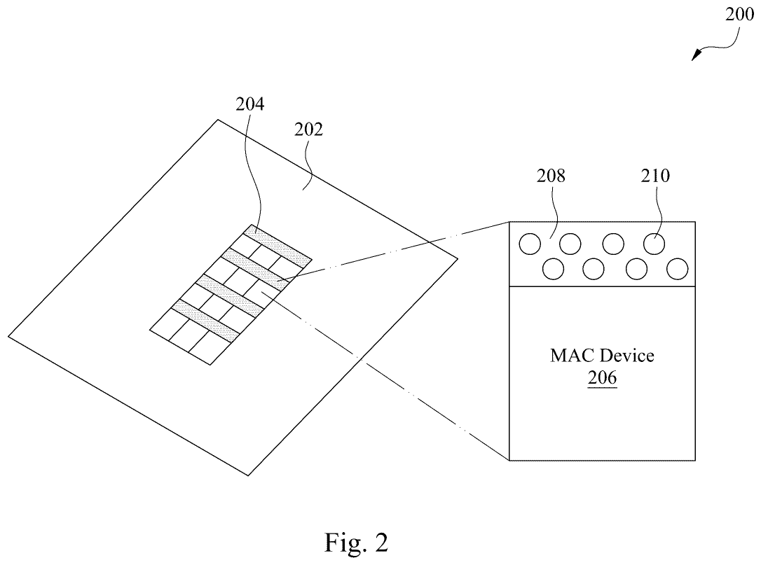

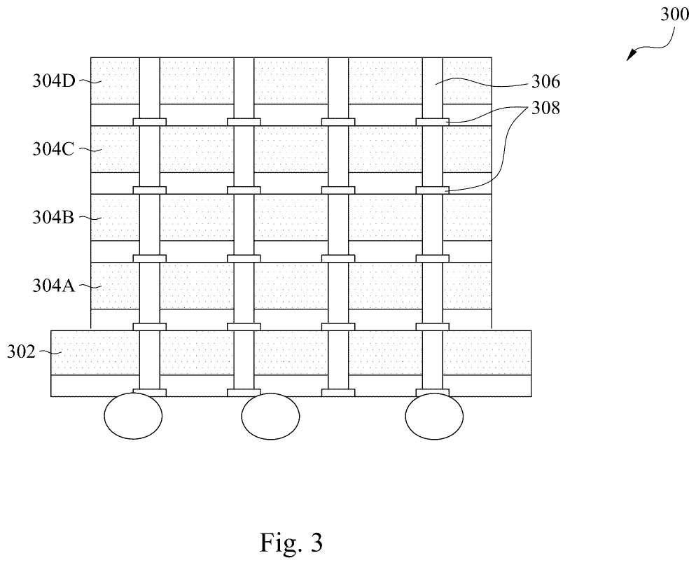

FIG. 1 illustrates a perspective block diagram of an example 3D accelerator circuit 100 implemented to accelerate generative artificial intelligence (AI) operations, in accordance with some embodiments of the present disclosure. The 3D accelerator circuit 100 is shown as including at least one MAC layer 102 having a MAC array (details of which are described in connection with FIG. 2) and one or more memory layers 104 stacked on top of the at least one MAC layer 102. In some implementations, and as shown in this example, the 3D accelerator circuit 100 can further include an input buffer 108, a global accumulator circuit 110, and a non-linear function circuit 112. In some implementations, the 3D accelerator circuit 100 can include controllers for the memory layers 104. In this example, the cut 114 represents a cross-section corresponding to the cross-sectional view 300 illustrated in FIG. 3.

The 3D accelerator circuit 100 may include one or more logic gates and sub-circuits, each of which may be constructed from one or more logic gates. Logic gates are electronic devices that perform logical operations on one or more input signals to produce a single output signal. Various embodiments of the circuits and logic gates that implement the 3D accelerator circuit 100 may include various transistors. The transistors described herein may have a certain type (n-type or p-type), but embodiments are not limited thereto. The transistors can be any suitable type of transistor including, but not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like.

The 3D tiled accelerator circuit 100 is shown as including at least one input buffer 108, which can be a buffer circuit that stores input data for one or more artificial intelligence operations. In some implementations, the 3D tiled accelerator circuit 100 may include multiple input buffers 108. Although shown in this example as being separate from the MAC layer 102, it should be understood that this representation is provided for visual clarity, and that the input buffer 108 can be included in circuitry of the MAC layer 102. In some implementations, the input buffer may be defined in a separate layer from the MAC layer 102, and electrically coupled to the MAC layer using one or more interconnect structures.

The input buffer 108 may include any number of memory elements, which may include dynamic random-access memory (DRAM) memory cells, static random-access memory (SRAM) cells, flash memory cells, eFuse memory cells, or any other type of memory cell capable of storing information electronically. The input buffer 108 may store an input vector for a generative artificial intelligence operation, such as one for vector-matrix multiplications performed by a MAC array of the MAC layer 102. The input buffer 108 can provide the input operand/vector to at least one MAC array of the MAC layer 102. The input buffer 108 may also receive data from, and be modified by, the non-linear activation circuit 112, in some implementations. For example, when performing a generative artificial intelligence operation, such as autoregressive text generation, the output of a first iteration may be used as input for a subsequent iteration. Interconnects and logic circuits can cause the non-linear activation circuit 112 to provide its output for storage the input buffer 108 for the subsequent iteration.

The input buffer 108 can store information received from one or more external circuits, such as other memory circuits or processing circuits. The input buffer 108 can include memory elements that store binary information of any suitable format, including floating-point data of various precision, integer data of various precision, or other types of electronic information. One or more control circuits may communicate with the input buffer 108 to coordinate read operations (e.g., from one or more components of the MAC layer 102) and/or write operations (e.g., from the non-linear activation circuit 112, other external circuits/components, etc.).

The 3D accelerator circuit 100 is shown as including at least one global accumulator circuit 110. The output of operations performed by MAC circuits of the MAC array of the MAC layer 102 can be provided as input to the global accumulator circuit 110. Although shown in this example as being separate from the MAC layer 102, it should be understood that this representation is provided for visual clarity, and that the global accumulator circuit 110 can be included in circuitry of the MAC layer 102. In some implementations, the global accumulator circuit 110 may be defined in a separate layer from the MAC layer 102, and electrically coupled to the MAC layer 102 using one or more interconnect structures.

For example, the global accumulator circuit 110 can combine partial sums produced by adder trees of the MAC layer 102 to produce an output for a cycle/iteration of a generative artificial intelligence operation. For example, the MAC array may generate one or more partial sums for a vector-matrix MAC operation between a set of weight values stored in the MAC array and a vector of input data in the input buffer 108. The partial sums can be combined using one or more adder circuits included in the global accumulator circuit 110. In some implementations, the global accumulator circuit 110 can provide multiple parallel outputs, depending on the type of operation being performed. Operations that are to be performed using the global accumulator circuit 110 can be configurable based on instructions received from other circuits in communication with the 3D accelerator circuit 100. In one example, the global accumulator circuit 110 can provide an output vector resulting from a vector-matrix multiplication performed using the MAC layer 102.

The 3D accelerator circuit 100 is shown as including at least one non-linear activation circuit 112. The non-linear activation circuit 112 can include logic gates, circuit components, or other logical circuits that perform one or more activation function operations and/or pooling operations. Although shown in this example as being separate from the MAC layer 102, it should be understood that this representation is provided for visual clarity, and that the non-linear activation circuit 112 can be included in circuitry of the MAC layer 102. In some implementations, the non-linear activation circuit 112 may be defined in a separate layer from the MAC layer 102, and electrically coupled to the MAC layer 102 using one or more interconnect structures.

In some implementations, output data produced by the global accumulator circuit 110 can be provided as input to the non-linear activation circuit 112. The non-linear activation circuit 112 can be an electronic circuit that includes various logic gates, transistors, or other logical components or devices that can process received data according to one or more activation function and/or a pooling function. An activation function can be a non-linear operation applied to each the outputs produced by the global accumulator circuit 110. Activation functions can be used to introduce non-linearity to data processed by the artificial intelligence model implemented by the 3D accelerator circuit 100. Pooling can be used to down-sample output values maps produced by the MAC operations described herein, reducing the spatial dimensions of the outputs in the aggregate while retaining information important for artificial intelligence operations.

In some implementation, the non-linear activation circuit 112 can be used to perform a max pooling operation, an average pooling operation, or a global pooling operation (e.g., a global average pooling operation, a global max pooling operation, etc.), among others. The output of the non-linear activation circuit 112 can, in some implementations, be stored in the input buffer 108 for further processing via the MAC layer 102. For example, after processing one set of input data stored in the input buffer 108 to produce a set of output data, different weight values/parameters stored in the memory layer(s) 104 can be used in one or more MAC operations implemented by the MAC layer 102. The output data/vector provided by the non-linear activation circuit 112 for storage in the input buffer 108 can then be used as input data for processing using the further weight/parameter values of the artificial intelligence model according to the techniques described herein. This process may be repeated until an output of the artificial intelligence model is produced, in some implementations.

The 3D accelerator circuit 100 is shown as including one or more memory layers 104. Although four memory layers 104 are shown in this example, it should be understood that any number of memory layers may be included in the 3D accelerator circuit 100. The memory layers 104 can include an array of memory banks, each of which can be coupled to one or more respective via connections 106. The via connections 106 in the 3D accelerator circuit 100 can be interconnect structures that facilitate communication between the memory layers 104 and the MAC layer 102. The via connections 106 can include any type of interconnect structures that facilitate transmission of electronic signals among layers in a 3D semiconductor device architecture, including but not limited to hybrid bonding (HB) connections and/or through-silicon vias (TSVs). The via connections 106 can include vertical interconnects that penetrate through the semiconductor substrate of the memory layer(s) 104, enabling data transfer between different layers of the circuit.

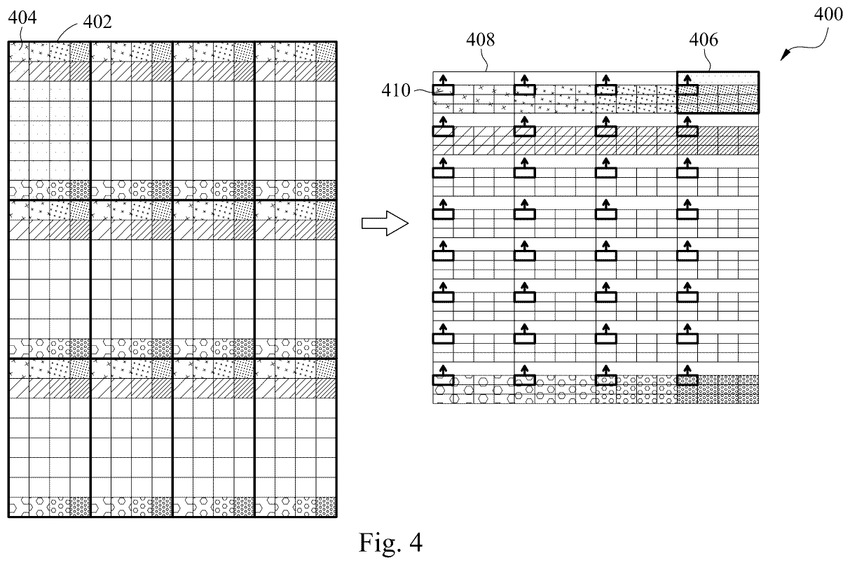

The via connections 106 are defined in parallel rows, as shown, to enable the content of memory banks/devices defined on the memory layers 104 be efficiently transferred to MAC circuits of the MAC layer 102. For example, the parallel rows of via connections can couple to corresponding MAC circuits of the MAC layer 102. In some implementations, the via connections 106 of a first memory layer 104 can couple to corresponding via connections 106 of a second memory layer 104 in the stack, which can enable data to be shifted through memory banks/devices of different memory elements. Further details of the memory banks/devices and their corresponding via connections 106 are described in connection with FIGS. 4-6.

The via connections 106 of a memory layer 104 can couple the memory banks/devices of the memory layer to a corresponding MAC circuit of the MAC layer 102. In some implementations, a memory layer 104 can include electrical routing, registers, buffers, or other circuitry to enable different memory devices to transmit data using the via connections 106. Electrically coupling the memory banks/devices using the via connections 106 can enable selective transfer of data, such as weight values, from the memory layers 104 to the MAC circuits of the MAC layer 102. This reduces memory access energy and delays and improves the overall performance of various artificial intelligence operations that are conventionally limited by memory bandwidth/latency and access power. In some implementations, via connections 106 can transmit data at an extremely high throughput to improve overall device performance.

When performing various artificial intelligence operations, the via connections 106 can be activated to transfer weight values and/or other data from the memory layers 104 to the MAC circuits in the MAC layer 102. In some implementations, the via connections 106 can transfer data in parallel, allowing multiple data elements to be accessed simultaneously from different memory banks/devices and provided to corresponding MAC circuits of the MAC layer 102. In some implementations, the memory layers 104 can include routing, elements, or logical circuitry that supports multiple data transfer protocols, and that can dynamically adjust the data transfer rates between the memory layer(s) 104 and the MAC circuits of the MAC layer 102. Data transfer from the memory layers 104 can be coordinated by one or more control circuits electrically coupled to the memory layers 104. In some implementations, the control circuits can be provided on the MAC layer 102.

Each memory layer 104 can include a set of memory banks, each of which can include a corresponding set of memory devices. Each memory layer 104 may include any number of memory elements, which may include DRAM memory cells, SRAM cells, flash memory cells, eFuse memory cells, or any other type of memory cell capable of storing information electronically. The memory elements of a memory layer 104 may be modified by one or more control circuits that write and/or read data to the memory elements of the memory layer 104. In some implementations, the memory elements of a memory layer 104 can store weight values or other parameters of an artificial intelligence model, such as a transformer-based model. The memory layer 104 can provide one or more of said parameters to the MAC layer 102 for processing. In some implementations, the memory layers 104 of the 3D accelerator can collectively store all weight values for a generative artificial intelligence model. In some implementations, the memory layers 104 can include circuitry that enables data to be rapidly written to the memory banks/elements of each memory layer 104 in parallel, significantly reducing the latency of performing memory-bound operations. Further details of the structure of the memory devices and their corresponding mapping to MAC circuits are described in connection with FIGS. 4-6.

FIG. 2 illustrates a perspective block diagram 200 of an example MAC array layer 202 that may be included in the 3D accelerator circuit of FIG. 1, in accordance with some embodiments of the present disclosure. The MAC array layer 202 is shown as including a MAC array 204. The diagram 200 also shows a zoomed view of an example MAC device 206 of the MAC array 204, which can be coupled to and in communication with an interconnect structure 208. The MAC array layer 202 can be similar to and include any of the structure and functionality of the MAC layer 102 of FIG. 1.

The MAC array layer 202 may include one or more logic gates and sub-circuits, each of which may be constructed from one or more logic gates. Logic gates are electronic devices that perform logical operations on one or more input signals to produce a single output signal. Various embodiments of the circuits and logic gates that implement the 3D accelerator circuit 100 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like.

The MAC layer 202 is shown as including a MAC array 204. The MAC array 204 can include one or more MAC devices 206. Each MAC device 206 in the MAC array 204 can include binary multiplication circuits, adder circuits, and further circuitry to facilitate data transfer, buffering, and other operations. The multiplication circuits can be any suitable circuit that can perform binary multiplication on integer or floating-point values, or both, in some implementations. Multiplier circuits can multiply two values, such as a value of input data and a weight/parameter value of an artificial intelligence model, to generate a product. Products from multiple iterations and/or multiply circuits can be accumulated using adder circuit(s) of the MAC devices 206 to generate one or more sums or partial sums resulting from MAC operation(s).

The adder circuits of a MAC device 206 can be any suitable adder circuit that accumulates products generated by the multiplier circuits, any may include full adders and carry look-ahead circuits, or the like. In some implementations, the MAC array 204 can include one or more adder trees, which can sum and accumulate values generated by the multiply circuits of the MAC device 206. In some implementations, the adder circuits of the MAC device 206 can include one or more registers or memory elements to store an output of the MAC device 206 over multiple processing cycles. For example, the adder circuit(s) can include one or more registers that receive and accumulate an output of the MAC device 206 of the MAC array 204 to perform an artificial intelligence operation. The register(s) can receive and accumulate the outputs of the multiplier circuit of the MAC device 206 until a sufficient number of multiplications have been performed to generate a partial sum for the MAC operation. The output of the adder circuits of each MAC device 206 can be provide as output to a global accumulator circuit (e.g., the global accumulator circuit 110 of FIG. 1).

The MAC layer 202 and/or the MAC array 204 can include one or more input registers, interconnect circuitry, or logical circuitry (e.g., registers, buffers, multiplexors, etc.) to receive input data from an input data buffer (e.g., the input buffer 108 of FIG. 1). In some implementations, the MAC array 204 and/or each MAC device 206 can include an input register. The input register can receive input data from the input buffer (e.g., the input buffer 108) of the MAC layer 202. The input register can include circuitry to write to, and read from, one or more memory elements of the input buffer of the MAC layer 202. In some implementations, the input register of the MAC device(s) 206 can implement pipeline parallelism, by storing subsequent input data for a next iteration of a MAC operation in the input buffer after providing input data to the arithmetic circuitry/components of the MAC device 206.

The MAC device 206 is shown as being coupled to and/or including an interconnect structure 208. The interconnect structure can include circuitry, logical elements (e.g., logic gates, multiplexors, etc.) to route data into and/or out of the MAC device 206 using one or more via structures 210. The interconnect structure 208 may include circuitry to selectively provide data to one or more layers of the 3D accelerator circuits described herein. In some implementations, control circuitry in communication with the interconnect structure 208 and/or the MAC device 206 can provide control signals that control input and/or output data of the MAC device 206. As described herein, the MAC device 206 can receive data from memory layers (e.g., the memory layers 104 of FIG. 1) and an input buffer (e.g., the input buffer 108 of FIG. 1) to perform one or more MAC operations. The interconnect structure 208 and/or other circuitry of the MAC layer 202 may include logical elements to route data into and out of the MAC device 206 to carry out the MAC operations described herein.

The interconnect structure 208 is shown as including one or more via structures 210. In this example, eight via structures 210 are shown. However, it should be understood that any number of via structures 210 may be provided in connection with a corresponding MAC device. In some implementations, the number of via structures 210 may correspond to a precision (e.g., number of bits, etc.) of the data that is to be processed using the MAC device 206. For example, eight via structures 210 can be provided to communicate 8-bit floating point values. As described herein, the interconnect structure 208 can be used to access and/or receive values (e.g., weight values) from one or more memory layers (e.g., memory layers 104) of a 3D accelerator circuit. The via structures 210 can include TSVs and may implement hybrid bonding between layers of the 3D accelerator circuit to facilitate communication between multiple layers. Further details of the interconnect structure 208 and the via structures 210 are described in connection with FIG. 3.

In this example, the MAC array 204 is shown as including twelve MAC devices 206, arranged in three columns and four rows. However, it should be understood that any suitable number of MAC devices 206 may be included in the MAC array 204 to perform the various techniques described herein. Each MAC device 206 can operate in parallel, such that each MAC device 206 generates a corresponding partial sum for the artificial intelligence iteration during the same cycle, in some implementations. The partial sums can be provided to a global accumulator circuit, as described herein, to generate an output of the MAC operation calculated using the MAC array 204.

FIG. 3 illustrates a cross-sectional diagram 300 illustrating interconnections between memory layers and the MAC layer of the 3D accelerator circuits described herein, in accordance with some embodiments of the present disclosure. In the cross-sectional diagram 300, an example 3D accelerator is depicted that shows multiple memory layers 304A-304D (sometimes generally referred to as a “memory layer(s) 304”) stacked on top of a MAC layer 302. The memory layers 304 may each be similar to, and include any of the structure and functionality of, the memory layer(s) 104 of FIG. 1. The MAC layer 302 can be similar to, and include any of the structure and functionality of, the MAC layer 102 of FIG. 1 or the MAC layer 202 of FIG. 2. In this arrangement, the MAC layer 302 can be defined on a first semiconductor die, and each memory layer 304 is defined on an additional semiconductor die.

The memory layers 304A-304D the 3D accelerator circuit are shown as being stacked on top of one another to form a multi-layered semiconductor die structure. Each memory layer 304A-304D can include an array of memory banks/devices that store weight values and other data required for the operations performed by the MAC layer 302. As shown, each of the memory layers 304 include a corresponding set of via structures 306 that join the memory layer 304 to another layer in the stack of the 3D accelerator (e.g., to another memory layer and/or the MAC layer 302) using at least one hybrid bond 308. Stacking the memory layers 304A-304D on top of the MAC layer 302 improves memory density and reduces routing complexity that would otherwise significantly decrease memory bandwidth in conventional 2D approaches.

The data that is to be processed by a MAC device/circuit of the MAC layer 302 can be stored in in the memory banks/elements of each memory layer 304 that are coupled to via structures 306 that are most proximate to the MAC device/circuit. This can minimize the amount of routing and buffer circuits needed to provide data stored in the memory banks/elements of the 3D accelerator circuit to the MAC circuits/devices of the MAC layer 302. In this example, memory banks/devices of the MAC layers 304 share via structures 306, which reduces overall device area and routing complexity within each memory layer. In some implementations, some memory layers 304 may not necessarily share via structures 306, and may be coupled directly to corresponding structures of the MAC layer 302 without being electrically coupled to via structures 306 of other memory layers.

In some implementations, the data can be subdivided among the memory devices/banks of each memory layer 304 such that simultaneous access of memory devices that share via structures 306 is avoided. This approach reduces the total area and the total number of via structures 306 within the 3D accelerator circuit without sacrificing memory bandwidth. In an example where the 3D accelerator circuit stores weight values for an artificial intelligence model, each memory layer 304 may store weight values for one or more layers of the artificial intelligence model, such that simultaneous access of memory elements among different memory layers 304 is minimized or entirely eliminated.

As described herein, the via structures 306 can be TSVs or other vertical interconnects that penetrate through the substrate of each memory layer 304A-304D and the MAC layer 302. The via structures 306 can be defined in parallel rows (sometimes referred to herein as “channels”), where each row provides data to one row of MAC circuits of the MAC layer 302, as described in further detail herein. The via structures 306 can be formed using any suitable Face-to-Back (F2B) process.

In this example, the via structure 306 of each memory layer 304 and MAC layer 302 are shown as being coupled to one or more hybrid bonds 308. The hybrid bonds 308 can be used to electrically and mechanically connect the memory layers 304 to one another and to the MAC layer 302. Forming hybrid bonds 308 can include the formation of metal-to-metal and/or dielectric-to-dielectric bonding techniques. The hybrid bonds 308 can provide a low-resistance path for data transfer between the memory layers 304 and the MAC layer 302, thereby reducing memory access energy and delays and improving the overall performance of the artificial intelligence operations. The hybrid bonds 308 can provide mechanical stability between the stacked memory layers 304 and the MAC layer 302.

In some implementations, due to size differences between the MAC devices (e.g., MAC devices 206 of FIG. 2) of the MAC layer 302 and the memory banks/elements of different memory layers 304, the via structures 306 of the MAC layer 302 may be coupled to additional interconnect structures within the MAC layer 302. The additional interconnect structures can compensate for the differences in footprint size between the MAC array (e.g., the MAC array 204 of FIG. 2) and the footprint of the memory banks/elements of the memory layers 304. In one example, the MAC array of the MAC layer may have a smaller footprint than the memory elements of the stacked memory layers 304. In such implementations, the MAC layer 302 may include additional routing metal, circuit components, or logical elements to route data from the via structures 306 to a corresponding MAC device of the MAC layer.

FIGS. 4, 5, and 6 illustrate example diagrams showing an example mapping between weight values of one or more layers of an artificial intelligence model, the memory banks/elements of different memory layers (e.g., the memory layer(s) 104 of FIG. 1), and the MAC devices (e.g., MAC devices 206) of the MAC layer of the 3D accelerator circuits described herein. This mapping is provided for example purposes, and it should be understood that the data that may be stored in the memory layers and processed by the MAC layer(s) of the 3D accelerator circuits described herein is configurable.

FIG. 4 illustrates a block diagram 400 showing an example mapping of a set of weight values to memory elements in a memory layer of the 3D accelerator circuits described herein, in accordance with some embodiments of the present disclosure. In this example, a set of data values 404 are subdivided into data tiles 402 for storage and processing by the 3D accelerator circuits described herein. The data values 404 may be, in one example, a single weight of a neural network or generative artificial intelligence model. In this example, the data values 404 are provided in a 24 by 16 matrix. To efficiently process the data values using the 3D accelerator circuits described herein, the data values 404 are sub-divided into a number of data tiles 402 that corresponds to a number of memory elements 410 in each memory bank 406 of a memory layer (e.g., the memory layer 104 of FIG. 1, the memory layer 304 of FIG. 3, etc.).

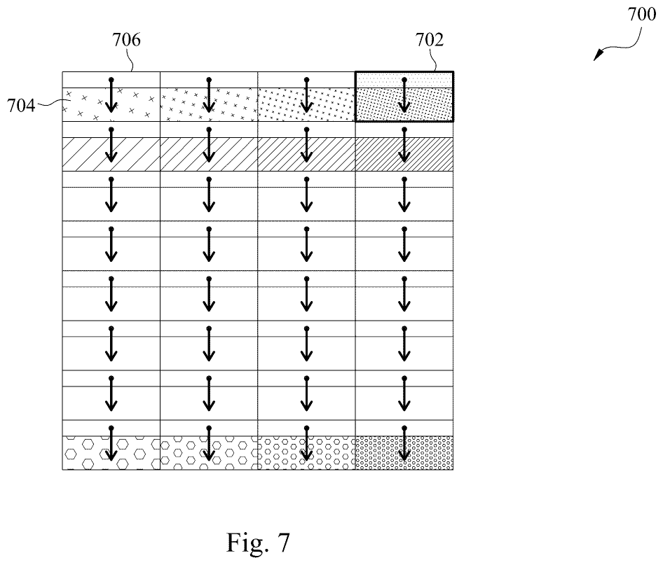

In this example representation, each memory layer of the 3D accelerator circuit includes 32 memory banks 406. The number of memory banks 406 within each memory layer correspond to the number of MAC devices provided in the MAC array of the MAC layer of the 3D accelerator circuit. In this example, 32 memory banks 406 are provided, which respectively correspond to 32 MAC devices in the MAC array shown and described in connection with FIG. 7. In this example, each memory bank 406 is shown as including 12 memory elements 410, each of which can store a respective data value 404. To store the data values 404 in the memory elements 410 of each memory bank 406, the data values 404 are sub-divided into a number of tiles 402 corresponding to the number of memory elements 410 of each memory bank 406. In this example, the data values 404 are subdivided into 12 data tiles 402.

In the illustrated example, the data values 404 of each tile 402 are shown as being stored in the memory banks 406 according to their respective coordinates within each tile 402. In this example, the top-left data value (by row-column) of each tile 402 is stored in the memory elements 410 of the top-left memory bank 406. As each of the data value tiles 402 include 32 data values 404 in this example, each data value 404 of each partition can be stored in a respective memory element 410 of a corresponding memory bank 406 corresponding to its row-column coordinate in the data value tile 402.

The mappings in the examples shown in FIGS. 4-6 are indicated by the shading of different data values 404 in the tiles 402 and each memory bank 406. In particular, each memory element 410 within a memory bank 406 is shaded the same color, indicating the respective data value 404 row-column coordinate of each tile 402 to which it corresponds. In some implementations, all data values 404 can be provided/stored in the memory elements 410 of each memory bank 406 in parallel. In another example, all data values can be pipelined such that all data values 404 can be written to the memory elements 410 of the memory banks 406 in a predetermined number of cycles. Although only a single memory layer is shown here, it should be understood that a larger number of data values 404 can be processed by storing data values in memory banks 406 of multiple memory layers, each of which may be updated/written to r using pipeline write operations. Data values can be written to each of the memory layers using a corresponding memory control circuit, which may be provided in one or more of the memory layers and/or the MAC layer of the 3D accelerator circuit.

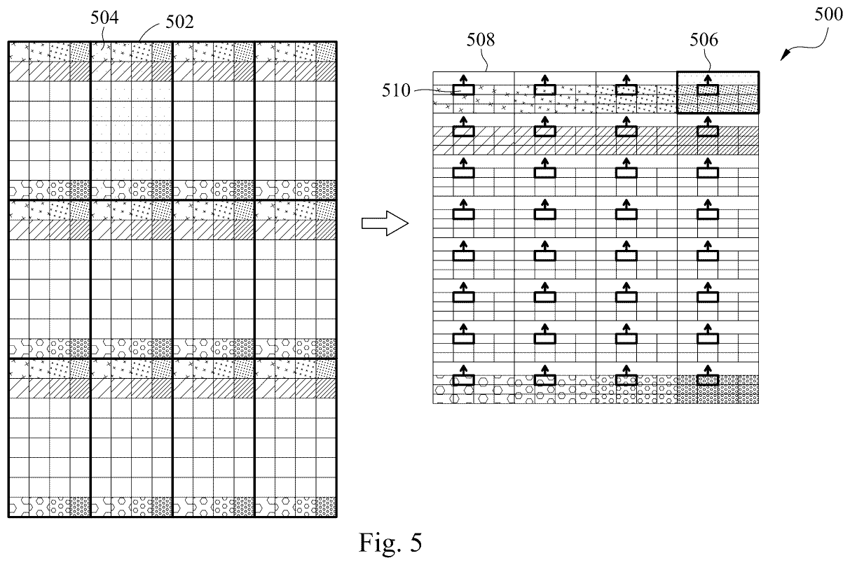

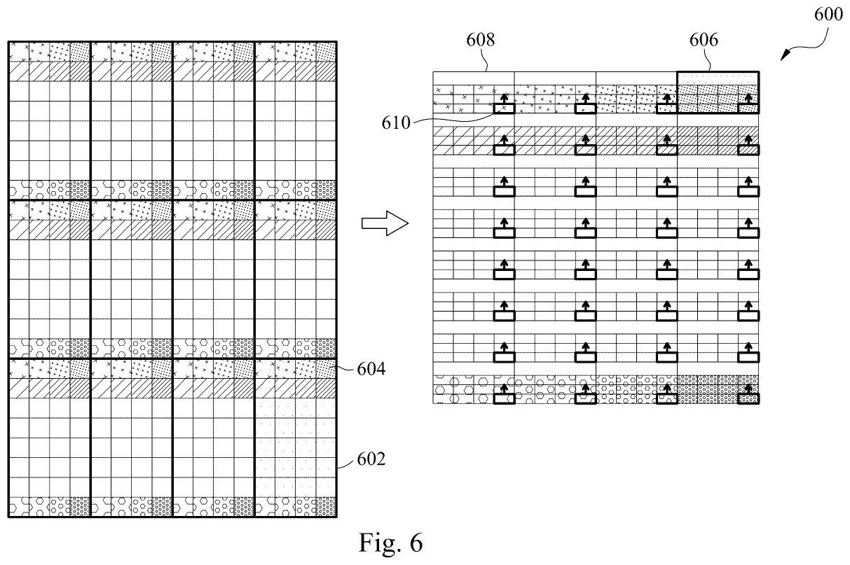

Each memory bank 406 can include logic that enables access to or provision of at least one data value 404 in at least one memory element 410 in parallel using the interconnect structure 408. The interconnect structure 408 may be similar to the via connections 106 of FIG. 1 and may include via structures or other interconnects to couple the memory banks of the memory layer to one or more corresponding MAC devices. In this example, each memory bank 406 is shown as providing the data value 404 stored in its top-left (by row-column) memory element 410 to the MAC devices of the MAC layer using the interconnect structures. As described in further detail in connection with FIGS. 5 and 6, this process may be repeated to efficiently process each weight value for a given tile in parallel.

FIG. 5 illustrates a block diagram 500 showing how other weight values stored according to the mapping shown in FIG. 4 can be processed using the 3D accelerator circuits described herein, in accordance with some embodiments of the present disclosure. In the diagram 500, illustrated is a subsequent processing iteration of data values 504, which have been subdivided into tiles 502 similar to the tiles 402 of data values 404 of FIG. 4. The diagram 500 can represent a subsequent processing iteration of the data values 404 of FIG. 4, in this example. As shown, a similar mapping between the data values 504 and the memory banks 506 has been performed, such that the memory elements 510 of each memory bank 506 store data values 504 having the same row-column coordinate within a respective tile 502.

As described herein, each memory bank 506 can include memory peripheral logic that enables access to or provisioning of at least one data value 504 in at least one memory element 510 in parallel using the interconnect structure 508. In this example, the next data value 504 has been provided to the interconnect structure 508 of each memory bank 506 in parallel, representing processing of the tile 502 of data values 504 that is second-from-the-left in the top row of tiles 502, as shown. In this example, each memory bank 506 is shown as providing the data value 504 stored in the memory element 510 at the top row in the second-to-the-left of the memory bank 506. In this example, a single memory element 510 is shown as providing a data element to the interconnect structure 508. However, it should be understood that this is an example representation, and that in some implementations, multiple memory elements 510 of a memory bank 506 can provide data values 504 to the interconnect structure 508 for processing by the MAC array of the MAC layer in parallel.

FIG. 6 illustrates a block diagram showing how further data values 604 stored according to the mapping shown in FIGS. 4 and 5 can be processed using the 3D accelerator circuits described herein, in accordance with some embodiments of the present disclosure. In the diagram 600, illustrated is a subsequent processing iteration of data values 604, which have been subdivided into tiles 602 similar to the tiles 402, 502 of data values 404, 504 of FIGS. 4 and 5. The diagram 600 can represent a final processing iteration of the data values 404 of FIG. 4, in this example. As shown, a similar mapping between the data values 604 and the memory banks 606 has been performed, such that the memory elements 610 of each memory bank 606 store data values 604 having the same row-column coordinate within a respective partition 602.

As described herein, each memory bank 606 can include memory peripheral logic that enables access to or provisioning of at least one data value 604 in at least one memory element 610 in parallel using the interconnect structure 608. In this example, the last data value 604 has been provided to the interconnect structure 608 of each memory bank 606 in parallel, representing processing of the bottom-right partition 602 of data values 604 in the process. In this example, each memory bank 606 is shown as providing the data value 604 stored in the bottom-right memory element 610 of the memory bank 606. In this example, a single memory element 610 is shown as providing a data element to the interconnect structure 608. However, it should be understood that this is an example representation, and that in some implementations, multiple memory elements 610 of a memory bank 606 can provide data values 604 to the interconnect structure 608 for processing by the MAC array of the MAC layer in parallel. The examples shown in FIGS. 4, 5, and 6 can represent the first, second, and final iterations in a process for performing MAC operations on the entire set of data values 404, with intermediate processing iterations of several tiles 602 omitted for visual clarity and conciseness.

FIG. 7 illustrates a block diagram showing how MAC devices 702 of a MAC array 700 of the 3D accelerator circuits described herein can process data values provided according to the mapping shown in FIGS. 4, 5, and 6, in accordance with some embodiments of the present disclosure. The MAC array 700 can be included in a MAC layer of a 3D accelerator circuit, as described in connection with FIGS. 1, 2, and 3. In this example, each MAC device 702 is shown as including a MAC circuit 704 in communication with an interconnect structure 706. The MAC circuit 704 can be similar to the MAC device 206 described in connection with FIG. 2 and the interconnect structure 706 can be similar to the interconnect structure 208 described in connection with FIG. 2.

In this example, data values provided from the memory elements stored according to the mapping shown in FIGS. 4, 5, and 6 can be processed by each MAC device in parallel. As shown, data values can be accessed or provided from the interconnect structure 608, which can couple each MAC device 702 to a corresponding memory bank (e.g., memory bank 406, 506, 606 of FIGS. 4, 5, and 6, etc.). The mapping between MAC devices 702 and corresponding memory elements and data values is shown according to the shading of each MAC device 702. In this example, each MAC device can process one data value at a time. Each row of MAC devices 702 can additionally receive all or a portion of an input vector or input data structure from an input buffer (e.g., the input buffer 108 of FIG. 1).

In one example, each row of MAC devices 702 can perform a multiplication operation of an input vector with at least a portion of a weight matrix (represented by the data values of FIGS. 4, 5, and 6) in the row direction. A partial sum can be calculated by summing values generated by the MAC devices 702 in the column direction. The partial sums generated by the MAC array 700 can be provided to a global accumulator circuit (e.g., the global accumulator circuit 110 of FIG. 1) to generate an output value. In this example, the MAC array 700 can be used to generate an output of a vector-matrix multiplication operation in a single cycle, which may be performed as part of an artificial intelligence model operation. Each MAC device 702 can access and process data values in parallel. As described in connection with FIGS. 4, 5, and 6, data values from each memory bank can be iteratively provided and processed by each MAC device 702 in parallel. In some implementations, the MAC devices 702 can include pipeline logic components that enable processing of a data value every cycle or every predetermined number of cycles.

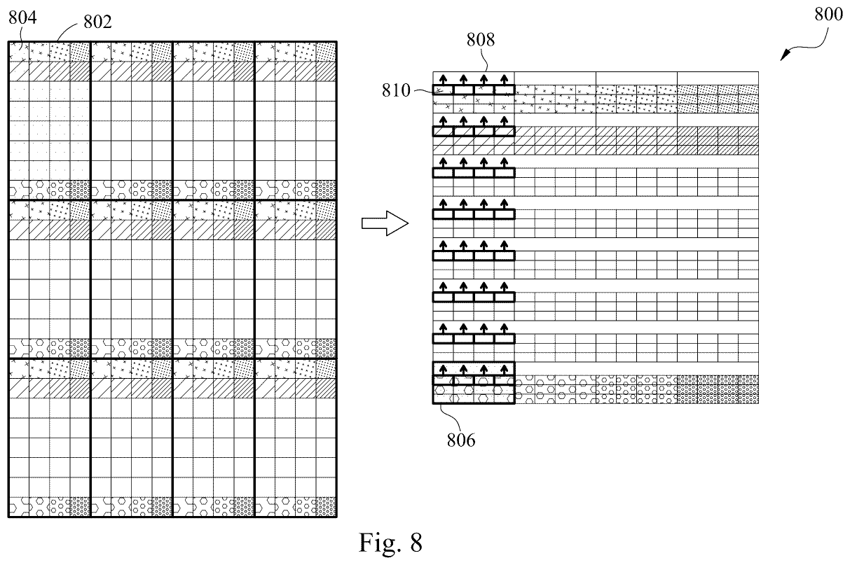

FIG. 8 illustrates a block diagram 800 showing another example mapping of a set of weight values to memory elements in a memory layer of the 3D accelerator circuits described herein, in accordance with some embodiments of the present disclosure. The diagram 800 shows an alternative mapping described in connection with FIGS. 4-6. In the diagram 800, illustrated is an example first processing iteration of data values 804, which have been subdivided into tiles 802 similar to the tiles 402 of data values 404 of FIG. 4. Similar to the arrangement described in connection with FIGS. 4-6, the data values 804 are sub-divided into a number of data tiles 802 that corresponds to a number of memory elements 810 in each memory bank 806 of a memory layer (e.g., the memory layer 104 of FIG. 1, the memory layer 304 of FIG. 3, etc.).

In this example, the top four memory elements 810 of the each memory bank 806 in the left-most column of memory banks 806 are provided to corresponding MAC devices of the MAC layer using the interconnect structures 808. The data values 804 provided from the four memory elements 810 can be mapped (e.g., by corresponding logical circuitry) to the corresponding row of four MAC devices (e.g., the MAC devices 702) that are vertically aligned with the memory banks 806. Implementing this type of mapping can reduce the total number of row activations and peripheral overhead at the expense of increased data movement in each memory layer (e.g., to map the corresponding weight values from each memory bank 806 to multiple MAC devices within the corresponding row).

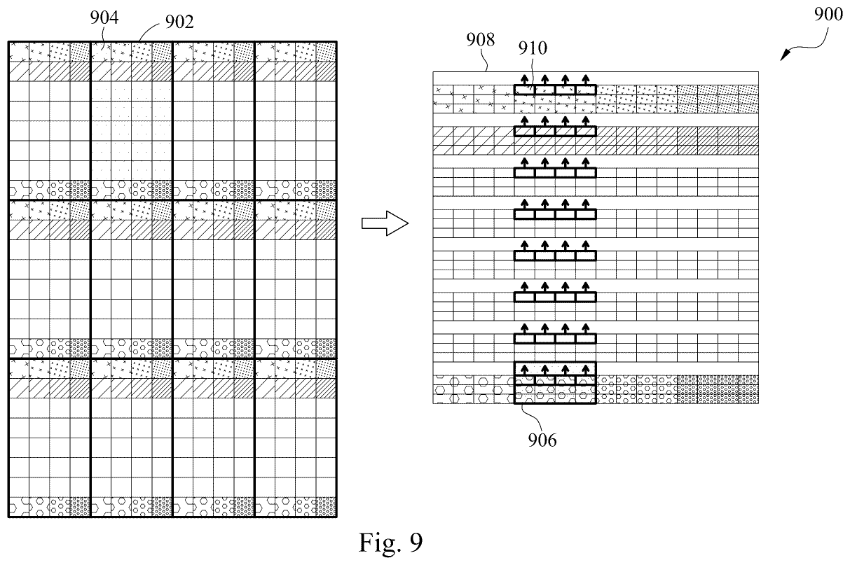

FIG. 9 illustrates a block diagram 900 showing how other data values stored according to the mapping shown in FIG. 8 can be processed using the 3D accelerator circuits described herein, in accordance with some embodiments of the present disclosure. In the diagram 900, illustrated is a subsequent processing iteration of data values 904, which have been subdivided into tiles 902 similar to the tiles 802 of FIG. 8. The diagram 900 can represent a subsequent processing iteration of the data values 804 of FIG. 8, in this example. As shown, a similar mapping between the data values 904 and the memory banks 906 has been performed, such that the memory elements 010 of each memory bank 906 store data values 904 having the same row-column coordinate within a respective tile 902.

In this example, the top row of four data values 904 in each memory bank 906 of the next column (e.g., second from the left) has been provided to the interconnect structure 908 of each memory bank 906 in parallel. As described in connection with FIG. 8, the data values 804 provided from the four memory elements 810 can be mapped (e.g., by corresponding logical circuitry) to the corresponding row of four MAC devices (e.g., the MAC devices 702) that are vertically aligned with each memory bank 806 providing data values 804 via the interconnect structures 908.

Data values can be iteratively provided in subsequent iterations, with each iteration providing data values from the next column of memory banks in the memory array. After providing the top row of four data values from the last (e.g., right-most) column, the next (e.g., middle row) of data values can be provided from the first (e.g., left-most) column of memory banks. This process can be repeated until all data values have been provided to and processed by the corresponding MAC devices of the MAC array (e.g., the MAC array described in connection with FIG. 7).

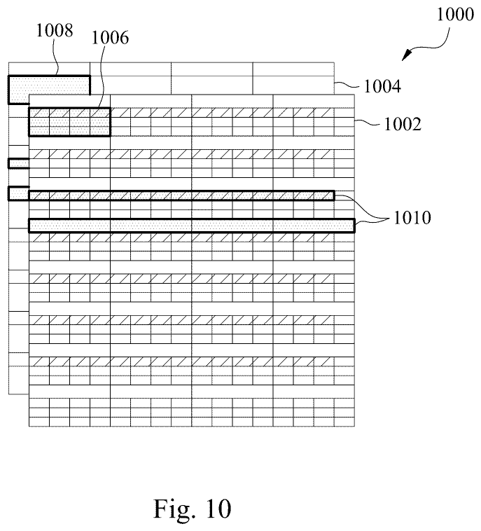

FIG. 10 illustrates a block diagram 1000 showing how a memory layer is aligned over MAC devices of a MAC array in the 3D accelerator circuits described herein, in accordance with some embodiments of the present disclosure. The diagram 100 illustrates how a memory tier 1002 (e.g., a memory array) can occupy the same two-dimensional area as a corresponding MAC array 1004 of the 3D accelerator circuits described herein. Although a single memory tier 1002 is shown in this example, it should be understood that the 3D accelerator circuits may include any number of memory tiers 1002. In implementations where the 3D accelerator circuits include multiple memory tiers 1002, the interconnect structures 1010 that couple the memory tier 1002 to the MAC array 1004 can be shared among memory tiers 1002. In such implementations, the data values can be mapped to memory elements of the memory tiers 1002 in a manner that minimizes concurrent access of multiple memory tiers 1002.

As shown, the MAC array 1004 includes multiple MAC devices 1008 that are vertically aligned with a corresponding memory partition 1006 of the memory tier 1002. In some implementations, the MAC device 1008 can occupy the same or similar area as the memory partition 1006. Maintaining a similar area between the MAC array 1004 and the memory tier(s) 1002 can minimize the energy during memory access, improving overall power consumption of the 3D accelerator circuits described herein.

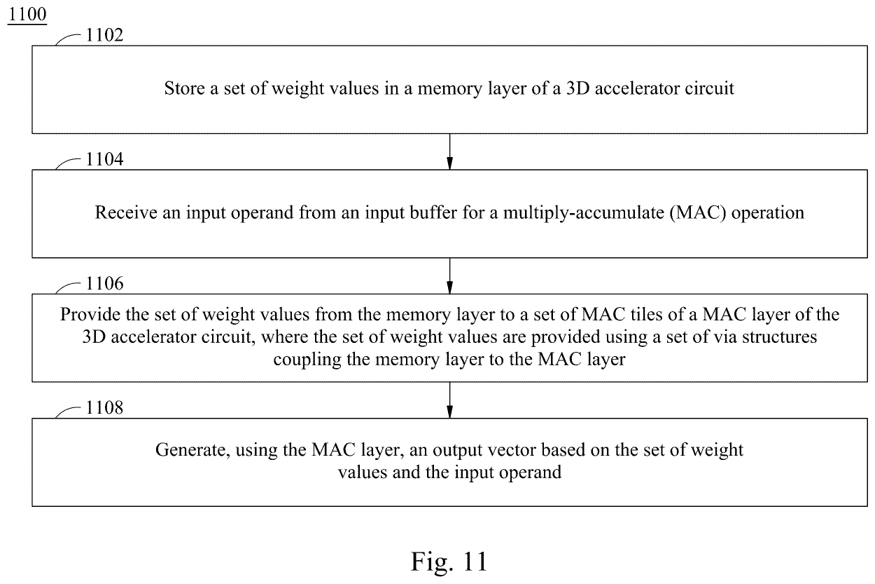

Referring to FIG. 11, illustrated is a flowchart of an example method 1100 to operate the disclosed circuits described herein, in accordance with some embodiments of the present disclosure. The method 1100 may be used to perform MAC operations or other artificial intelligence operations. The method 1100 may be performed in connection with any of the systems, devices, circuits, or components described herein. It is understood that additional operations may be provided before, during, and after the method 1100 of FIG. 11, and that some other operations may only be briefly described herein.

In brief overview, the method 1100 starts with operation 1102, including storing a set of weight values (e.g., a data values 404, 504, 604) in a memory layer of a 3D accelerator circuit (e.g., the 3D accelerator circuit 100, etc.) The method 1100 proceeds with operation 1104, including receiving an input operand (e.g., an input vector) from an input buffer (e.g., the input buffer 108) for a MAC operation. The method 1100 proceeds with operation 1106, including providing the set of weight values from the memory layer to a set of MAC tiles of a MAC layer of the 3D accelerator circuit. The method 1100 proceeds with operation 1108, including generating, using the MAC layer, an output vector based on the set of weight values and the input operand.

Referring to operation 1102, a set of weight values can be stored in a memory layer of a 3D accelerator circuit. The set of weight values may be provided for storage in one or more memory elements (e.g., the memory elements 410, 510, 610) of corresponding memory banks (e.g., memory banks 406, 506, 606) of one or more memory layers of the 3D accelerator circuit using an interconnect structure (e.g., the via connections 106, the via structures 306, the hybrid bonds 308, etc.). The weight values can be stored in memory banks that are in direct connection to corresponding MAC devices that are to process the weight values (e.g., for an artificial intelligence operation). The memory bank can be coupled to the MAC device using a corresponding interconnect structure. The interconnect structure may include one or more TSVs and/or hybrid bonds to couple the memory layer to the MAC layer. In some implementations, each memory layer can store a subset of a weight matrix of an artificial intelligence model. In some implementations, each memory layer can store one or multiple weight matrices corresponding to one or more layers of an artificial intelligence model.

Referring to operation 1104, an input operand (e.g., an input vector) can be received from an input buffer (e.g., the input buffer 108, etc.). The input vector can be an input vector that is to be multiplied by a weight tile written into the MAC array. In some implementations, the input vector is to be subsequently multiplied by multiple weight tiles written into MAC array one after the other. The input vector may include a vector for an artificial intelligence operation, such as a vector storing numerical tokens, embeddings, or other numerical data used in generative artificial intelligence operations. The input vector may be provided as an output of a prior iteration of the 3D accelerator circuits described herein. In some implementations, the input buffer can provide the input operand to each row of MAC devices in the MAC array of the MAC layer, such that each MAC device can perform at least a portion of a vector-matrix MAC operation.

Referring to operation 1106, the set of weight values can be provided from a memory layer to the corresponding MAC devices of the MAC layer of the 3D accelerator for the MAC operation. The weight values can be provided to the MAC layer using the one or more TSVs and/or hybrid bonds that couple the memory layer to the MAC layer. As described herein in connection with FIGS. 4-9, weight values can be stored in memory banks that are vertically aligned with the MAC devices that are to process those weight values. The weight values can be provided in parallel to each of the MAC devices using the via structures. In some implementations, the weight values can be provided to the MAC devices of the MAC layer in a single cycle.

Referring to operation 1108, an output is generated using the MAC array defined on a MAC layer based on the provided weight values and the input operand. Each MAC device of the MAC array can process at least a portion of the MAC layer using the corresponding weight value provided from one or more memory layers to generate a set of partial sums. The partial sums generated using the MAC devices can be accumulated into an ouptut vector. For example, in some implementations, the MAC layer can be coupled to or can include a global accumulator circuit. In such implementations, the partial sums generated by the MAC devices (or columns of MAC devices) of the MAC array can be provided to the global accumulator circuit to generate an output vector. The output vector can be a result of a MAC operation between the input vector and one or more weight matrices stored in the first and second memory layers.

In an example where the MAC operation is part of an artificial intelligence operation, the output vector can be provided to a non-linear activation circuit (e.g., the non-linear activation circuit 112). The non-linear activation circuit may perform one or more of an activation function and/or a pooling function using the output vector generated by the global accumulator circuit. The output of the non-linear activation circuit can be provided as a second output vector, in some implementations. In some implementations, the second output vector of the non-linear activation circuit may be stored in the input buffer for a subsequent artificial intelligence operation. To perform multiple iterations of the MAC operation, the MAC array can iteratively retrieve (or be provided) corresponding additional sets of weight values from one or more of the memory layers to perform further MAC calculations.

In one aspect of the present disclosure, a system is disclosed. The system includes a plurality of memory layers each comprising a set of memory banks. The system includes a MAC layer comprising a MAC array having a plurality of MAC devices. Each MAC device of the plurality of MAC devices is coupled to a respective memory bank of the set of memory banks by at least one via structure.

In another aspect of the present disclosure, a multiply-accumulate device is disclosed. The multiply-accumulate device includes a MAC array comprising a plurality of MAC devices defined on a first semiconductor die. The multiply-accumulate device includes an input buffer configured to store at least one input vector. The multiply-accumulate device includes a plurality of interconnect structures each corresponding to a respective row of the plurality of MAC devices. The plurality of interconnect structures comprising a semiconductor via coupled to at least one second semiconductor die. The MAC array is configured to receive the at least one input vector from the input buffer. The MAC array is configured to receive a plurality of data values from the at least one second semiconductor die via the plurality of interconnect structures. The MAC array is configured to generate a set of partial sums using the at least one input vector and the plurality of data values.

In yet another aspect of the present disclosure, a method is disclosed. The method can include storing a set of weight values in a memory layer of a 3D accelerator circuit. The method can include receiving an input operand from an input buffer for a MAC operation. The method can include providing the set of weight values from the memory layer to a set of MAC tiles of a MAC layer of the 3D accelerator circuit. The set of weight values are provided using a set of via structures coupling the memory layer to the MAC layer. The method can include generating, using the MAC layer, an output vector based on the set of weight values and the input operand.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a plurality of memory layers each comprising a set of memory banks; and
a multiply-accumulate (MAC) layer including a MAC array having a plurality of MAC devices,
wherein each MAC device of the plurality of MAC devices is coupled to a respective memory bank of the set of memory banks by at least one via structure.

2. The system of claim 1, wherein the set of memory banks and the plurality of MAC devices are each arranged in a predetermined number of rows and columns.

3. The system of claim 2, wherein each of the plurality of MAC devices is coupled to a single memory bank within each memory layer of the plurality of memory layers.

4. The system of claim 1, further comprising an input buffer circuit that provides at least a portion of an input vector to at least one row of the plurality of MAC devices of the MAC array.

5. The system of claim 1, wherein the MAC layer is defined on a first semiconductor die, and the plurality of memory layers are defined on a plurality of second semiconductor dies stacked on top of the first semiconductor die.

6. The system of claim 1, wherein a column of the plurality of MAC devices of the MAC array are configured to generate a partial sum.

7. The system of claim 6, further comprising a global accumulator circuit in communication with the MAC array, the global accumulator circuit configured to receive a respective partial sum from each column of the plurality of MAC devices of the MAC array.

8. The system of claim 1, wherein the set of memory banks of each of the plurality of memory layers are coupled to the MAC array using a shared interconnect structure.

9. The system of claim 1, wherein the set of memory banks comprises a predetermined number of memory elements.

10. The system of claim 1, wherein the plurality of memory layers are coupled to the MAC layer using Face-to-Back (F2B) stacking with hybrid bonds and TSVs.

11. A multiply-accumulate (MAC) device, comprising:
a MAC array comprising a plurality of MAC devices defined on a first semiconductor die;
an input buffer configured to store at least one input vector; and
a plurality of interconnect structures each corresponding to a respective row of the plurality of MAC devices, the plurality of interconnect structures comprising a semiconductor via coupled to at least one second semiconductor die, wherein the MAC array is configured to:
receive the at least one input vector from the input buffer,
receive a plurality of data values from the at least one second semiconductor die via the plurality of interconnect structures, and
generate a set of partial sums using the at least one input vector and the plurality of data values.

12. The MAC device of claim 11, further comprising:
a global accumulator circuit configured to:
receive the set of partial sums from the MAC array; and
generate an output vector corresponding to a vector-matrix multiplication operation between the at least one input vector and the plurality of data values.

13. The MAC device of claim 12, wherein the non-linear activation circuit is further configured to provide the output vector to the input buffer for a subsequent iteration of an artificial intelligence operation.

14. The MAC device of claim 11, wherein the plurality of MAC devices are configured to receive the plurality of data values from the at least one second semiconductor die in a single cycle.

15. The MAC device of claim 11, wherein each of the plurality of MAC devices are configured to iteratively:
receive at least one data value of a weight matrix of an artificial intelligence model; and
generate an output product based on at least a portion of the at least one input vector and the at least one data value.

16. The MAC device of claim 15, wherein the MAC array is further configured to generate a respective partial sum of the set of partial sums by summing the output product of a subset of the plurality of MAC devices in a respective column of the MAC array.

17. The MAC device of claim 11, wherein the first semiconductor die is coupled to the at least one second semiconductor die using hybrid bonds and TSVs.

18. A method, comprising:
storing a set of weight values in a memory layer of a three-dimensional (3D) accelerator circuit;
receiving an input operand from an input buffer for a multiply-accumulate (MAC) operation;
providing the set of weight values from the memory layer to a set of MAC tiles of a MAC layer of the 3D accelerator circuit, the set of weight values provided using a set of via structures coupling the memory layer to the MAC layer; and
generating, using the MAC layer, an output vector based on the set of weight values and the input operand.

19. The method of claim 18, further comprising generating, by a global accumulator circuit of the MAC circuit, the output based on a plurality of partial sums generated by the MAC array.

20. The method of claim 19, further comprising providing the set of weight values from the memory layer to the set of MAC tiles in a single cycle.
